(19) United States
(12) Patent Application Publication
(10) Pub. No.: US 2009/0156117 A1
(43) Pub. Date: Jun. 18, 2009

(54) HIGH RELIABILITY SATELLITE NETWORK DELIVERY

(75) Inventor: Frederick M. Baumgartner, Elizabeth, CO (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/959,408

(22) Filed: Dec. 18, 2007

(51) Int. Cl. H04B 7/19

(52) U.S. Cl. 455/13.2; 455/13.3

(57) ABSTRACT

A communication satellite comprises at least one antenna configured to communicate with at least one ground terminal over a first communication link in a first frequency band and a second communication link in a second frequency band. The first communication link and the second communication link are for communicating the same information. A satellite communication system comprises a first satellite having a first antenna configured to communicate with a ground terminal over a first communication link in a first frequency band and a second communication link in a second frequency band. The satellite communication system further comprises a second satellite having a second antenna configured to communicate with the ground terminal over a third communication link in the first frequency band and a fourth communication link in the second frequency band. The first communication link and the second communication link are for communicating the same information. The third communication link and the fourth communication link are for communicating the same information

### BACKGROUND

1. Field

The present invention relates to satellites and, in particular, relates to high reliability satellite network delivery.

2. Background

Satellites that communicate with ground terminals are frequently subject to a number of causes of communication failure. For example, when a ground terminal, a satellite, and the sun are aligned (i.e., when the satellite undergoes a solar transit), the signal from the satellite may be lost in the surrounding solar radiation. Additionally, when rain clouds pass between a satellite and the ground terminal with which it communicates, the raindrops in the clouds may play havoc with communication signals of certain wavelengths (e.g., wavelengths about four times the average raindrop diameter). Accordingly, it is desirable to provide better reliability in satellite communications.

### SUMMARY

Various aspects of the subject technology solve the foregoing problems by providing high reliability satellite network delivery. By establishing multiple communication links in different frequencies between satellites and ground stations, each of which redundantly communicating the same data, the relative advantages of the different frequencies may be exploited to provide more reliable communications.

In an aspect, a communication satellite comprises at least one antenna configured to communicate with at least one ground terminal over a first communication link in a first frequency band and a second communication link in a second frequency band. The first communication link and the second communication link are for communicating the same information.

In another aspect, a satellite communication system comprises a first satellite having a first at least one antenna configured to communicate with at least one ground terminal over a first communication link in a first frequency band and a second communication link in a second frequency band. The satellite communication system further comprises a second satellite having a second at least one antenna configured to communicate with the at least one ground terminal over a third communication link in the first frequency band and a fourth communication link in the second frequency band. The first communication link and the second communication link are for communicating the same information. The third communication link and the fourth communication link are for communicating the same information.

In yet another aspect, a method for communicating with a satellite communication system comprises a first transmitting step of transmitting a first frequency band signal between at least one satellite and at least one ground terminal. The method further comprises a second transmitting step of transmitting a second frequency band signal between the at least one satellite and the at least one ground terminal simultaneously with the first transmitting step. The first frequency band signal and the second frequency band signal contain the same information.

In yet another aspect, a communication satellite comprises communication means configured to communicate with at least one ground terminal over a first communication link in a first frequency band and a second communication link in a second frequency band. The first communication link and the second communication link are for communicating the same information.

In yet another aspect, a machine-readable medium comprises instructions for communicating with a satellite communication system. The instructions comprise code for a first transmitting step of transmitting a first frequency band signal between at least one satellite and at least one ground terminal, and a second transmitting step of transmitting a second frequency band signal between the at least one satellite and the at least one ground terminal simultaneously with the first transmitting step. The first frequency band signal and the second frequency band signal contain the same information.

In yet another aspect, a processor for communicating with a satellite communication system is configured to transmit a first frequency band signal between at least one satellite and at least one ground terminal, and to transmit a second frequency band signal between the at least one satellite and the at least one ground terminal simultaneously with the first transmitting step. The first frequency band signal and the second frequency band signal contain the same information.

### BRIEF DESCRIPTION OF THE DRAWINGS

FIG. 1 illustrates a system including a communication satellite in accordance with one aspect of the subject technology;

FIG. 2 illustrates a system including a communication satellite in accordance with one aspect of the subject technology;

FIG. 3 illustrates a system including a communication satellite in accordance with one aspect of the subject technology;

FIG. 4 illustrates a system including a communication satellite in accordance with one aspect of the subject technology;

FIG. 5 illustrates a system including a communication satellite in accordance with one aspect of the subject technology;

FIG. 6 illustrates a satellite communication system in accordance with one aspect of the subject technology;

FIG. 7 is a flow chart illustrating a method for communicating with a satellite communication system in accordance with one aspect of the subject technology;

FIG. 8 illustrates a communication satellite in accordance with one aspect of the subject technology; and

FIG. 9 is a block diagram illustrating a computer system with which certain aspects of the subject technology may be implemented.

### DETAILED DESCRIPTION

According to one aspect of the subject technology, multiple communication links at different frequencies are provided between a satellite and a ground terminal. The communication links are used to communicate the same data redundantly. One communication link may be in a frequency resistant to rain fade, while another is in a frequency resistant to solar transit losses.

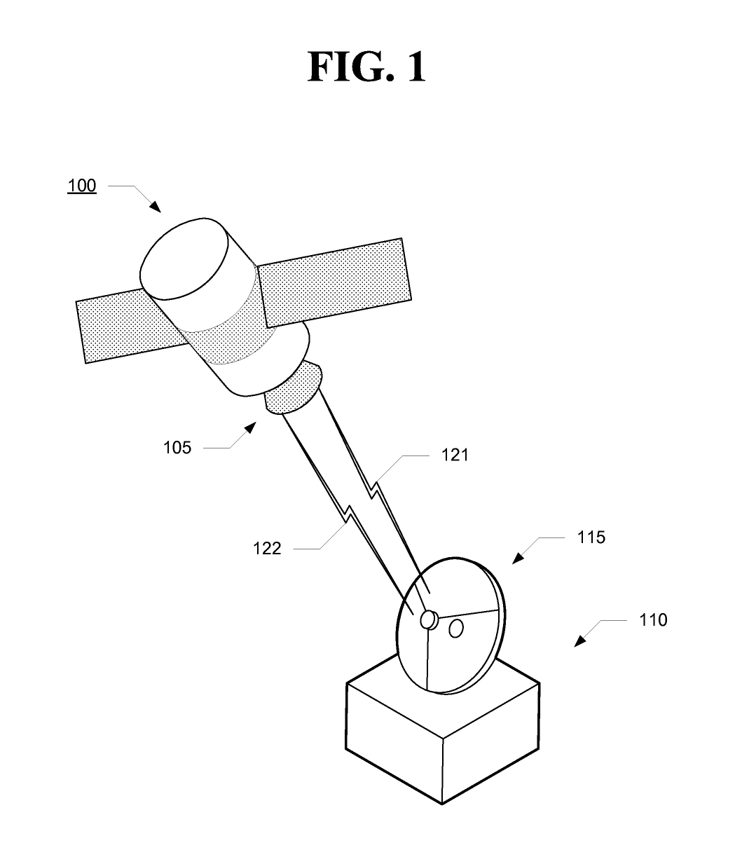

For example, FIG. 1 illustrates a communication satellite in accordance with one aspect of the subject technology. Communication satellite 100 includes an antenna 105 configured to communicate with an antenna 115 of ground terminal 110 over first 121 and second 122 communication links. First communication link 121 is in a C band frequency (e.g., between 4 and 8 GHz), and second communication link 122 is in a Kᵤ band frequency (e.g., between 11.2 and 18 GHz). Both communication links 121 and 122 are used for simultaneously communicating the same information.

As used herein, a “C band” frequency may be any frequency, or band of frequencies, between about 4 GHz and about 8 GHz. For example, a C band frequency may include a 3.7-4.2 GHz band for downlink (i.e., from the satellite to the ground station) and a 5.9-6.4 GHz band for uplink (i.e., from the ground station to the satellite). These C band frequencies enjoy less interference from intervening rain clouds (i.e., less rain fade). As used herein, a “Kᵤ band” frequency may be any frequency, or band of frequencies, between about 11.2 GHz and about 18 GHz. For example, a Kᵤ band frequency may include a 11.7-12.2 GHz band for downlink, and a 14.0-14.5 GHz band for uplink. These Kᵤ band frequencies enjoy better resistance to solar transit fades.

While exemplary aspects of the subject technology have been illustrated with respect to satellites communicating in C band and Kᵤ band frequencies, the scope of the present invention is not limited to these arrangements. Rather, satellites may communicate over two or more frequencies in any number of different frequency bands. For example, satellites may communicate over any two or more frequencies from the L band, the S band, the C band, the X band, the Kᵤ band, the K band, the Kₐ band, the V band, the W band, and the like.

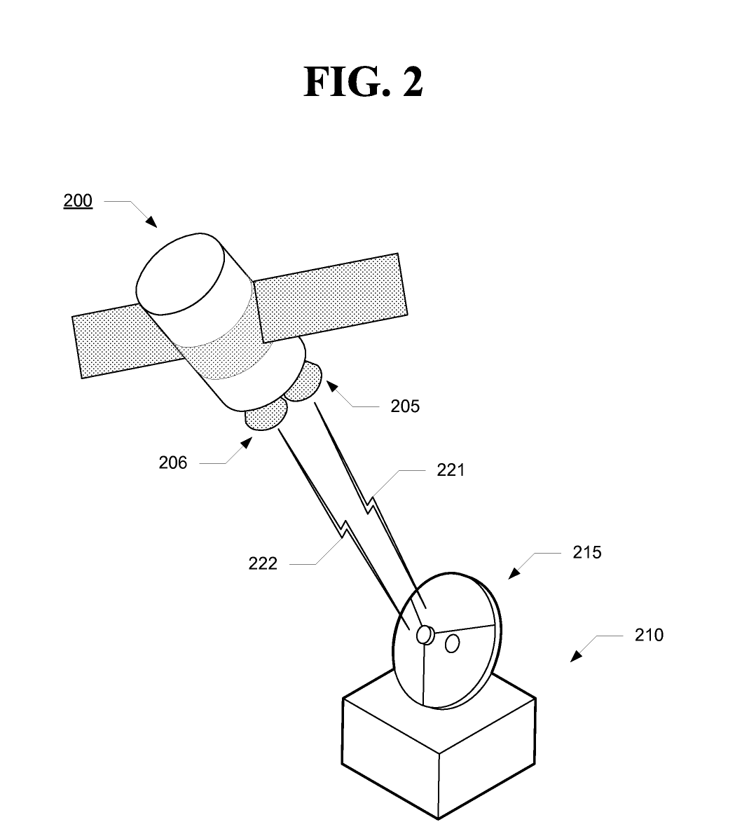

While satellite 100 is illustrated in FIG. 1 having only a single antenna 105, the scope of the present invention is not limited to such a configuration. Rather, any number of antennas may be used to generate multiple communication links in different frequencies for providing high reliability satellite network delivery. For example, FIG. 2. illustrates a communication satellite in accordance with another aspect of the subject technology, in which two antennas are used to provide two separate communication links. Communication satellite 200 includes two antennas 205 and 206 configured to communicate with an antenna 215 of ground terminal 210 over first 221 and second 222 communication links, respectively. First communication link 221 is in a C band frequency, and second communication link 222 is in a Kᵤ band frequency. Both communication links 221 and 222 are used for simultaneously communicating the same information.

While exemplary aspects of the subject technology have been illustrated with respect to satellites having either one or two antennas, the scope of the present invention is not limited to these arrangements. Rather, satellites with any number of antennas may be provided. For example, a satellite may have two antennas, each configured to communicate over two frequencies to a single ground station. Alternatively, a satellite may have more than two antennas, each of which may be configured to communicate over one or both frequencies with one or more ground stations.

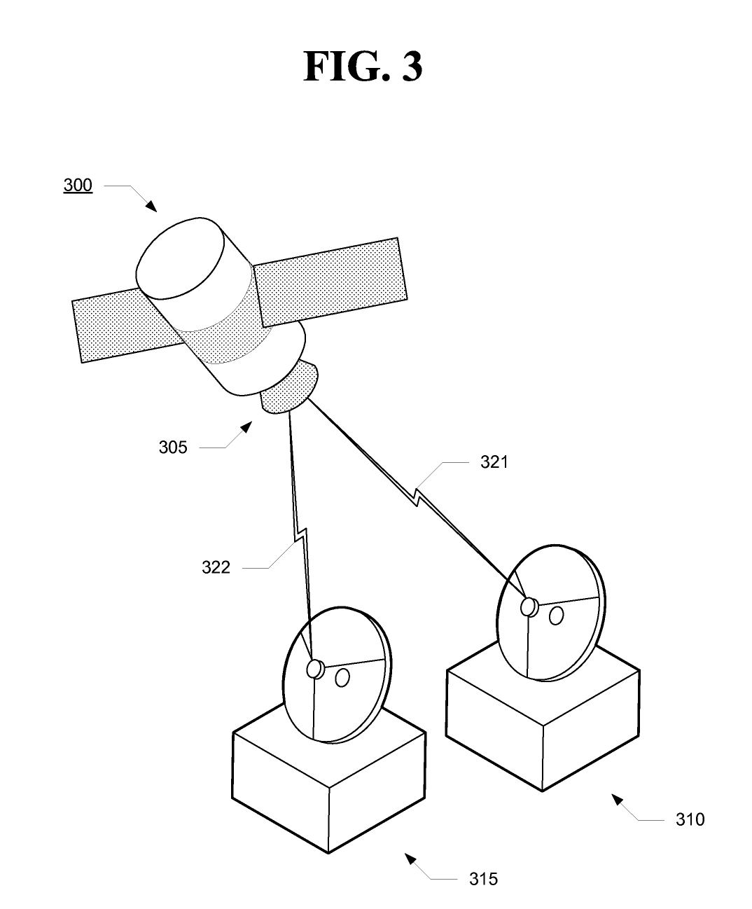

According to another aspect of the subject technology, a satellite may communicate with multiple ground stations to further improve the redundancy and reliability of the satellite network delivery. For example, FIG. 3. illustrates a communication satellite in accordance with yet another aspect of the subject technology in which multiple ground stations communicate with the satellite. Communication satellite 300 includes an antenna 305 configured to communicate with ground terminals 310 and 315 over first 321 and second 322 communication links, respectively. First communication link 321 is in a C band frequency, and second communication link 322 is in a Kᵤ band frequency. Both communication links 321 and 322 are used for simultaneously communicating the same information.

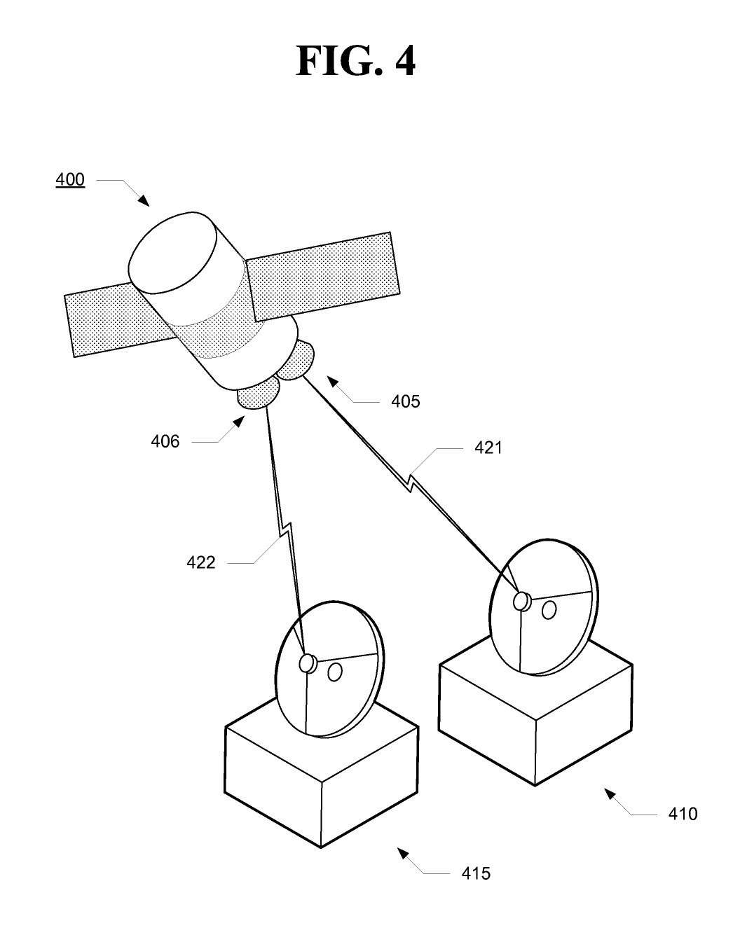

FIG. 4 illustrates a communication satellite in accordance with another aspect of the subject technology in which two antennas are used to communicate two separate communication links to two separate ground stations. Communication satellite 400 includes two antennas 405 and 406 configured to communicate with two ground terminals 410 and 415 over first 421 and second 422 communication links, respectively. First communication link 421 is in a C band frequency, and second communication link 422 is in a Kᵤ band frequency. Both communication links 421 and 422 are used for simultaneously communicating the same information.

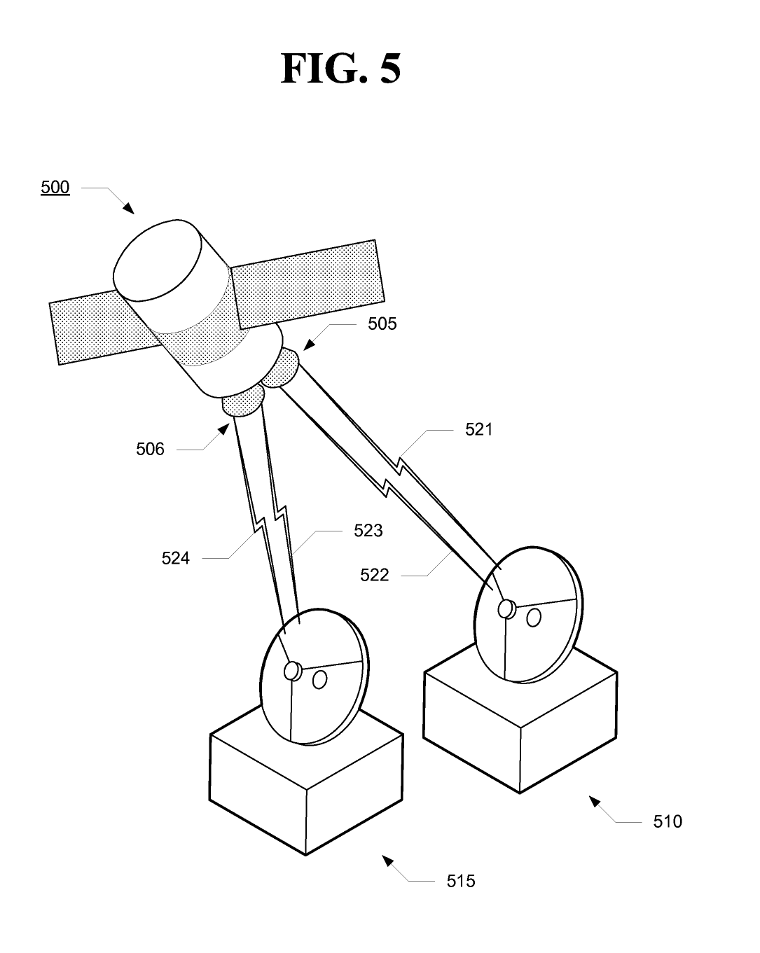

While exemplary aspects of the subject technology have been illustrated with respect to single satellites communicating with either one or two ground stations, the scope of the present invention is not limited to these arrangements. Rather, a satellite may communicate with any number of ground stations over redundant communication links in different frequencies. For example, a satellite may communicate with three or more ground stations. Moreover, each ground station may communicate with the satellite over one or both frequencies. For example, FIG. 5 illustrates a communication satellite in accordance with another aspect of the subject technology in which two antennas are used to communicate two separate communication links to two separate ground stations. Communication satellite 500 includes two antennas 505 and 506 configured to communicate with two ground terminals 510 and 515 over two links each (i.e., antenna 505 communicates with ground terminal 510 over first 521 and second 522 communication links, and antenna 506 communicates with ground terminal 515 over third 523 and fourth 524 communication links). First and third communication links 521 and 523 are in a C band frequency, and second and fourth communication links 522 and 524 are in a Kᵤ band frequency. Each pair of communication links (i.e., communication links 521 and 522 from antenna 505 and communication links 523 and 524 from antenna 506) are used for simultaneously communicating the same information.

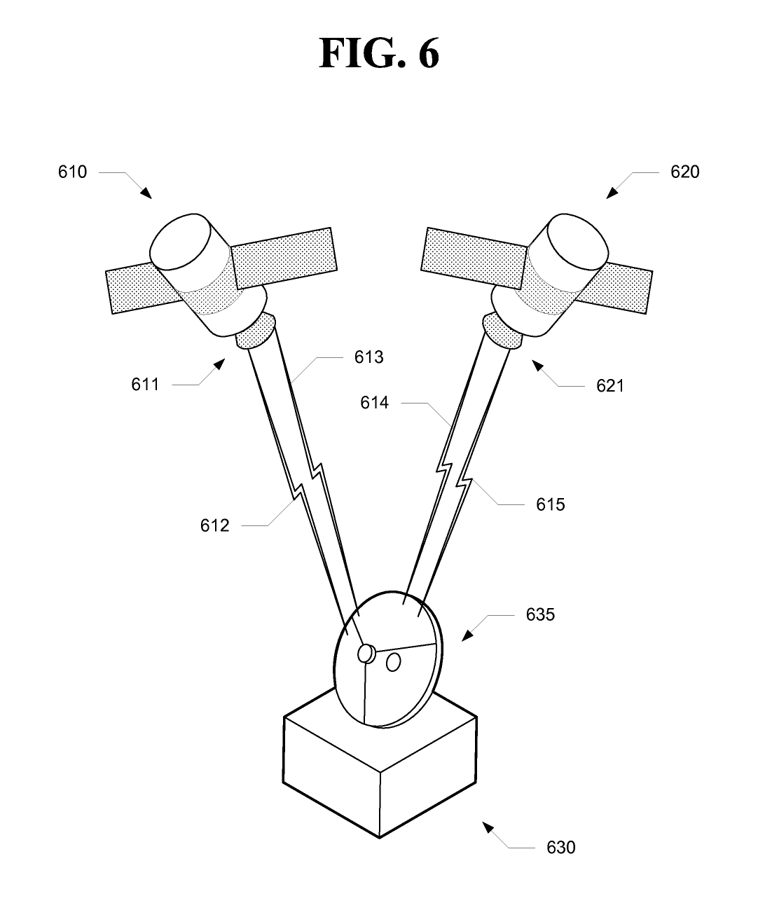

According to another aspect of the subject technology, a communication system may incorporate satellite diversity to further improve the redundancy and reliability of the satellite network delivery. For example, FIG. 6 illustrates a satellite communication system in accordance with one aspect of the subject technology in which multiple satellites communicate with a single ground station. The system includes two satellites 610 and 620. Satellite 610 includes an antenna 611 configured to communicate with an antenna 635 of ground terminal 630 over first 612 and second 613 communication links. First communication link 612 is in a C band frequency, and second communication link 613 is in a Kᵤ band frequency. Both communication links 612 and 613 are used for simultaneously communicating the same information. Satellite 620 includes an antenna 621 configured to communicate with antenna 635 of ground terminal 630 over third 614 and fourth 615 communication links. Third communication link 614 is in a C band frequency, and fourth communication link 615 is in a Kᵤ band frequency. Both communication links 614 and 615 are used for simultaneously communicating the same information.

While the communication system illustrated in FIG. 6 is illustrated with reference to only two satellites, the scope of the present invention is not limited to such a configuration. Rather, any number of satellites may be used to generate multiple communication links in different frequencies for providing high reliability satellite network delivery. Moreover, a satellite communication system may communicate with multiple ground stations, as illustrated in greater detail above with reference to FIGS. 3, 4 and 5.

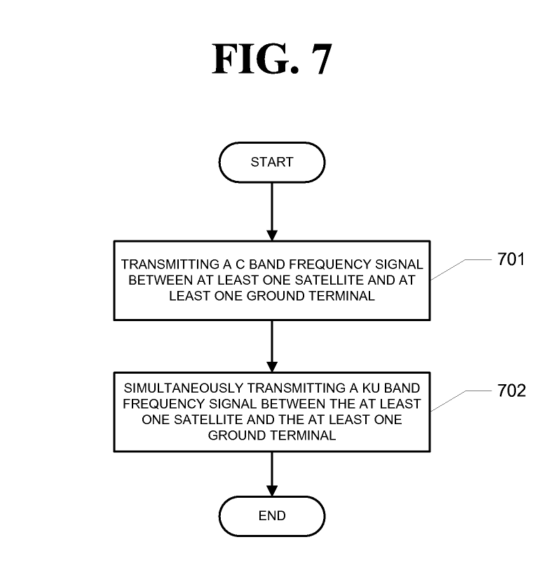

FIG. 7 is a flow chart illustrating a method for communicating with a satellite communication system. The method beings with step 701, in which a C band frequency signal is transmitted between at least one satellite and at least one ground terminal. The method continues with step 702, in which a Kᵤ band frequency signal is transmitted between the at least one satellite and the at least one ground terminal simultaneously with the first transmitting step. The C band frequency signal and the Kᵤ band frequency signal contain the same information.

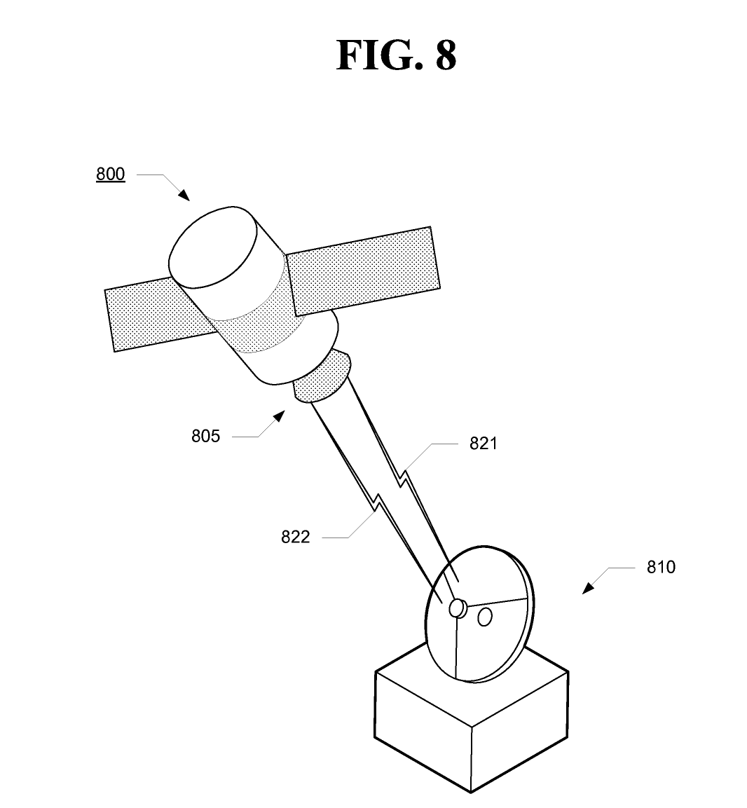

FIG. 8 illustrates a communication satellite in accordance with one aspect of the subject technology. Communication satellite 800 includes communication module 805 configured to communicate with ground terminal 810 over first 821 and second 822 communication links. First communication link 821 is in a C band frequency, and second communication link 822 is in a Kᵤ band frequency. Both communication links 821 and 822 are used for simultaneously communicating the same information.

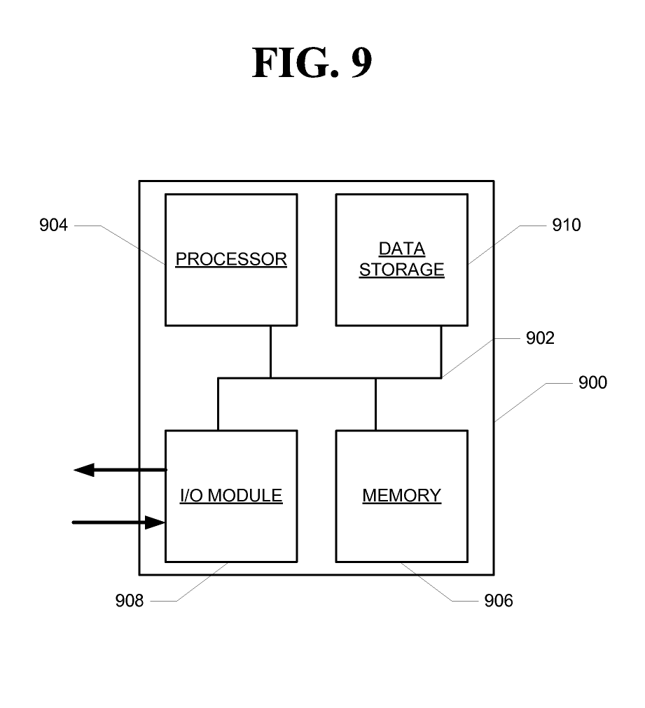

FIG. 9 is a block diagram that illustrates a computer system 900 upon which an aspect may be implemented. Computer system 900 includes a bus 902 or other communication mechanism for communicating information, and a processor 904 coupled with bus 902 for processing information. Computer system 900 also includes a memory 906, such as a random access memory (“RAM”) or other dynamic storage device, coupled to bus 902 for storing information and instructions to be executed by processor 904. Memory 906 may also be used for storing temporary variable or other intermediate information during execution of instructions to be executed by processor 904. Computer system 900 further includes a data storage device 910, such as a magnetic disk or optical disk, coupled to bus 902 for storing information and instructions.

Computer system 900 may be coupled via I/O module 908 to a display device (not illustrated), such as a cathode ray tube (“CRT”) or liquid crystal display (“LCD”) for displaying information to a computer user. An input device, such as, for example, a keyboard or a mouse may also be coupled to computer system 900 via I/O module 908 for communicating information and command selections to processor 904.

According to one aspect, communicating with a satellite communication system is performed by a computer system 900 in response to processor 904 executing one or more sequences of one or more instructions contained in memory 906. Such instructions may be read into memory 906 from another machine-readable medium, such as data storage device 910. Execution of the sequences of instructions contained in main memory 906 causes processor 904 to perform the process steps described herein. One or more processors in a multi-processing arrangement may also be employed to execute the sequences of instructions contained in memory 906. In alternative aspects, hard-wired circuitry may be used in place of or in combination with software instructions to implement various aspects. Thus, aspects are not limited to any specific combination of hardware circuitry and software.

The term “machine-readable medium” as used herein refers to any medium that participates in providing instructions to processor 904 for execution. Such a medium may take many forms, including, but not limited to, non-volatile media, volatile media, and transmission media. Non-volatile media include, for example, optical or magnetic disks, such as data storage device 910. Volatile media include dynamic memory, such as memory 906. Transmission media include coaxial cables, copper wire, and fiber optics, including the wires that comprise bus 902. Transmission media can also take the form of acoustic or light waves, such as those generated during radio frequency and infrared data communications. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, a carrier wave, or any other medium from which a computer can read.

Those of skill in the art would appreciate that the various illustrative blocks, modules, elements, components, methods, and algorithms described herein may be implemented as electronic hardware, computer software, or combinations of both. Furthermore, these may be partitioned differently than what is described. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application.

It is understood that the specific order or hierarchy of steps or blocks in the processes disclosed is an illustration of exemplary approaches. Based upon design preferences, it is understood that the specific order or hierarchy of steps or blocks in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A communication satellite comprising:
at least one antenna configured to communicate with at least one ground terminal over a first communication link in first frequency band and a second communication link in a second frequency band,
wherein the first communication link and the second communication link are for communicating the same information.

2. The communication satellite according to claim 1, wherein the at least one antenna comprises a first antenna configured to communicate with the at least one ground terminal over the first communication link and a second antenna configured to communicate with the at least one ground terminal over the second communication link.

3. The communication satellite according to claim 1, wherein the first frequency band is a C band, and the second frequency band is a Kᵤ band.

4. The communication satellite according to claim 3, wherein the at least one antenna comprises a first antenna configured to communicate with the first ground terminal over the first communication link and a second antenna configured to communicate with the second ground terminal over the second communication link

5. A satellite communication system comprising:
a first satellite having a first at least one antenna configured to communicate with at least one ground terminal over a first communication link in a first frequency band and a second communication link in a second frequency band; and
a second satellite having a second at least one antenna configured to communicate with the at least one ground terminal over a third communication link in the first frequency band and a fourth communication link in the second frequency band,
wherein the first communication link and the second communication link are for communicating the same information, and
wherein the third communication link and the fourth communication link are for communicating the same information.

6. The satellite communication system according to claim 5, wherein the first at least one antenna comprises a first antenna configured to communicate with the at least one ground terminal over the first communication link and a second antenna configured to communicate with the at least one ground terminal over the second communication link.

7. The satellite communication system according to claim 5, wherein the first frequency band is a C band, and the second frequency band is a Kᵤ band.

8. The satellite communication system according to claim 5, wherein the at least one ground terminal comprises a first ground terminal with which the first at least one antenna is configured to communicate over the first communication link and a second ground terminal with which the second at least one antenna is configured to communicate over the third communication link.

9. A method for communicating with a satellite communication system, comprising:
a first transmitting step of transmitting a first frequency band signal between at least one satellite and at least one ground terminal; and
a second transmitting step of transmitting a second frequency band signal between the at least one satellite and the at least one ground terminal simultaneously with the first transmitting step,
wherein the first frequency band signal and the second frequency band signal contain the same information.

10. The method according to claim 9, wherein:
the at least one satellite comprises a first satellite and a second satellite,
the first transmitting step comprises transmitting the first frequency band signal between the first satellite and the at least one ground terminal, and
the second transmitting step comprises transmitting the second frequency band signal between the second satellite and the at least one ground terminal.

11. The method according to claim 9, wherein:
the at least one satellite comprises a satellite having a first antenna and a second antenna,
the first transmitting step comprises transmitting the first frequency band signal between the first antenna and the at least one ground terminal, and
the second transmitting step comprises transmitting the second frequency band signal between the second antenna and the at least one ground terminal.

12. The method according to claim 9, wherein:
the at least one ground terminal comprises a first ground terminal and a second ground terminal,
the first transmitting step comprises transmitting the first frequency band signal between the at least one satellite and the first ground terminal, and
the second transmitting step comprises transmitting the second frequency band signal between the at least one satellite and the second ground terminal.

13. The method according to claim 9, wherein the first frequency band is a C band, and the second frequency band is a Kᵤ band.

14. A communication satellite comprising:
communication means configured to communicate with at least one ground terminal over a first communication link in a first frequency band and a second communication link in a second frequency band,
wherein the first communication link and the second communication link are for communicating the same information.

15. The communication satellite according to claim 14, wherein the communication means comprise first communication means configured to communicate with the at least one ground terminal over the first communication link and second communication means configured to communicate with the at least one ground terminal over the second communication link.

16. The communication satellite according to claim 14, wherein the first frequency band is a C band, and the second frequency band is a Kᵤ band.

17. The communication satellite according to claim 16, wherein the communication means comprises first communication means configured to communicate with the first ground terminal over the first communication link and second communication means configured to communicate with the second ground terminal over the second communication link

18. A machine-readable medium comprising instructions for communicating with a satellite communication system, the instructions comprising code for:
a first transmitting step of transmitting a first frequency band signal between at least one satellite and at least one ground terminal; and
a second transmitting step of transmitting a second frequency band signal between the at least one satellite and the at least one ground terminal simultaneously with the first transmitting step,
wherein the first frequency band signal and the second frequency band signal contain the same information.

19. The machine-readable medium according to claim 18, wherein:
the at least one satellite comprises a first satellite and a second satellite,
the first transmitting step comprises transmitting the first frequency band signal between the first satellite and the at least one ground terminal, and
the second transmitting step comprises transmitting the second frequency band signal between the second satellite and the at least one ground terminal.

20. The machine-readable medium according to claim 18, wherein:
the at least one satellite comprises a satellite having a first antenna and a second antenna,
the first transmitting step comprises transmitting the first frequency band signal between the first antenna and the at least one ground terminal, and
the second transmitting step comprises transmitting the second frequency band signal between the second antenna and the at least one ground terminal.

21. The machine-readable medium according to claim 18, wherein:
the at least one ground terminal comprises a first ground terminal and a second ground terminal,
the first transmitting step comprises transmitting the first frequency band signal between the at least one satellite and the first ground terminal, and
the second transmitting step comprises transmitting the second frequency band signal between the at least one satellite and the second ground terminal.

22. The machine-readable medium according to claim 18, wherein the first frequency band is a C band, and the second frequency band is a Kᵤ band.

23. A processor for communicating with a satellite communication system, the processor being configured to:
transmit a first frequency band signal between at least one satellite and at least one ground terminal; and
transmit a second frequency band signal between the at least one satellite and the at least one ground terminal simultaneously with the first transmitting step,
wherein the first frequency band signal and the second frequency band signal contain the same information.

24. The processor according to claim 23, wherein:
the at least one satellite comprises a satellite having a first antenna and a second antenna,
the processor is configured to transmit the first frequency band signal between the first antenna and the at least one ground terminal, and
the processor is configured to transmit the second frequency band signal between the second antenna and the at least one ground terminal.

25. The processor according to claim 23, wherein the first frequency band is a C band, and the second frequency band is a Kᵤ band.
